(19) United States
(12) Patent Application Publication
(10) Pub. No.: US 2026/0343353 A1
(43) Pub. Date: Oct. 29, 2026

(54) METHOD FOR ENHANCED CELL RE-SELECTION

(71) Applicant: Continental Automotive Technologies GmbH, Hannover (DE)

(72) Inventors: Andreas ANDRAE, Frankfurt am Main (DE); Shah Rikin, Langen (DE); David Gonzalez Gonzalez, Egelsbach (DE); Hojin KIM, Regensburg (DE); Reuben GEORGE STEPHEN, Singapore (SG); Shravan Kumar KALYANKAR, Singapore (SG); Osvaldo GONSA, Frankfurt (DE)

(73) Assignee: Continental Automotive Technologies GmbH, Hannover (DE)

(21) Appl. No.: 19/471,820

(22) PCT Filed: Apr. 2, 2024
(86) PCT No.: PCT/EP2024/058840

§ 371 Date: Oct. 2, 2025

(30) Foreign Application Priority Data
Apr. 5, 2023 (DE) 10 2023 203 190.6

(51) Int. Cl. H04W 36/08; H04W 36/00; H04W 74/0833

(52) U.S. Cl. CPC H04W 36/08; H04W 36/0061; H04W 74/0833

(57) ABSTRACT

Method for enhanced cell re-selection, wherein UE receives a mapping from network/gNB and if there is data to transmit, UE determines candidate cell for cell re-selection and for potentially performing random access at candidate cell based on provided mapping.

### CROSS REFERENCE TO RELATED APPLICATIONS

This application is the U.S. National Phase Application of PCT International Application No. PCT/EP2024/058840, filed Apr. 2, 2024, which claims priority to German Patent Application No. 10 2023 203 190.6, filed Apr. 5, 2023, the contents of such applications being incorporated by reference herein.”

### TECHNICAL FIELD

The evolution and large-scale deployment of fifth generation “5G” wireless networks over the next few years will require complementary 5G services by offering ubiquitous and reliable coverage across numerous geographies. Terrestrial networks are currently focusing on delivery of 5G services to areas already being served by existing cellular technologies, but the unique capabilities of non-terrestrial networks can help expand the reach of 5G technology in the realization of new use cases. The satellite communications industry is picking up pace with new constellations of satellite deployments available today that are offering services to consumers, in addition to ongoing research into making these deployments serve larger footprints, providing more reliable service and becoming more cost-effective as more satellite are deployed. Currently, there is increasing interest and participation in industry forums from the satellite communication industry, with companies and organizations convinced of the market potential for an integrated satellite and terrestrial network infrastructure in the context of 5G communications

5G deployments have been steadily ramping up across the globe with dozens of terrestrial network operators. While initially, 5G services have been offered to consumers with smart phones, there is also a significant desire by network operators to offer 5G services to enterprise and massive IoT (internet of Things) and MTC (machine type communication) devices. Demand for service continuity is expected to further drive the network evolution and expansion into non-traditional areas. Non-Terrestrial Networks, or NTN, have been part of gradual shift of research focus and the industrial push towards 5G-Advanced leading into sixth generation (6G) systems.

Satellite-based communication can potentially play an important role in leveraging communication infrastructure to deliver 5G services in the future and bridge the digital divide. Generally, satellite-based architecture leverages Geostationary Earth Orbit (GEO), Medium Earth Orbit (MEO), and Low Earth Orbit (LEO) systems which can collectively provide coverage across altitudes ranging from 36,000 km to 400 km. These satellites can be either stationary or can orbit around the Earth in the form of constellations to provide services. Overall, there are tradeoffs in performance and deployment cost among different satellite systems (LEO, MEO, GEO) that need to be taken into consideration.

### BACKGROUND

As it is depicted in FIG. 1, 3GPP TR 38.821 cites: “Considering the large cell size of non-terrestrial networks, many devices may be served within a single cell. Depending on constellation assumptions (e.g., propagation delay and satellite speed) and UE density, a potentially very large number of UEs may need to perform HO at a given time, leading to possibly large signaling overhead and service continuity challenges.”

| | | Time to | Average |
|---|---|---|---|
| Cell | Approximate | HO all UEs | HO Rate |
| Diameter | Cell Area | in cell | (in + out) |
| (km) | (km²) | (s) | (UEs/s) |
| 50 | 1964 | 6.61 | 19824 |
| 100 | 7854 | 13.23 | 9904 |
| 250 | 49087 | 33.07 | 3962 |
| 500 | 196000 | 66.14 | 1982 |
| 1000 | 785000 | 132.28 | 990 |

TS38.331 v17.3.0 describes a cell reselection. The SystemInformation message is used to convey one or more System Information Blocks or Positioning System Information Blocks. All the SIBs or posSIBs included are transmitted with the same periodicity.

SIB3 contains neighboring cell related information relevant only for intra-frequency cell re-selection. The IE includes cells with specific re-selection parameters as well as exclude-listed cells.

SIB4 contains information relevant for inter-frequency cell re-selection (i.e., information about other NR frequencies and inter-frequency neighboring cells relevant for cell re-selection), which can also be used for NR idle/inactive measurements. The IE includes cell re-selection parameters common for a frequency as well as cell specific re-selection parameters. Among others:
cellReselectionPriority: This specifies the absolute priority for NR frequency or E-UTRAN frequency
cellReselectionSubPriority: This specifies the fractional priority value added to cellReselectionPriority for NR frequency or E-UTRAN frequency.
Thresh_{X,HighP}: This specifies the Srxlev threshold (in dB) used by the UE when reselecting towards a higher priority RAT/frequency than the current serving frequency. Each frequency of NR and E-UTRAN might have a specific threshold.
Thresh_{X,HighQ}: This specifies the Squal threshold (in dB) used by the UE when reselecting towards a higher priority RAT/frequency than the current serving frequency. Each frequency of NR and E-UTRAN might have a specific threshold.
Thresh_{X,LowP}: This specifies the Srxlev threshold (in dB) used by the UE when reselecting towards a lower priority RAT/frequency than the current serving frequency. Each frequency of NR and E-UTRAN might have a specific threshold.
Thresh_{X,LowQ}: This specifies the Squal threshold (in dB) used by the UE when reselecting towards a lower priority RAT/frequency than the current serving frequency. Each frequency of NR and E-UTRAN might have a specific threshold.
Thresh_{Serving,LowP}: This specifies the Srxlev threshold (in dB) used by the UE on the serving cell when reselecting towards a lower priority RAT/frequency.
Thresh_{Serving,LowQ}: This specifies the Squal threshold (in dB) used by the UE on the serving cell when reselecting towards a lower priority RAT/frequency.

This means as a conclusion that the usage of signal strength and signal quality thresholds are baseline.

TS38.304 v17.3.0 describes in 5.2.4.5 NR Inter-frequency and inter-RAT Cell Reselection criteria:

If threshServingLowQ is broadcast in system information and more than 1 second has elapsed since the UE camped on the current serving cell, cell reselection to a cell on a higher priority NR frequency or inter-RAT frequency than the serving frequency shall be performed if:

A cell of a higher priority NR or EUTRAN RAT/frequency fulfils Squal>Thresh_{X,HighQ} during a time interval Treselection_{RAT}

Otherwise, cell reselection to a cell on a higher priority NR frequency or inter-RAT frequency than the serving frequency shall be performed if:

A cell of a higher priority RAT/frequency fulfils Srxlev>Thresh_{X,HighP} during a time interval Treselection_{RAT}; and

More than 1 second has elapsed since the UE camped on the current serving cell.

Cell reselection to a cell on an equal priority NR frequency shall be based on ranking for intra-frequency cell reselection as defined in clause 5.2.4.6.

If threshServingLowQ is broadcast in system information and more than 1 second has elapsed since the UE camped on the current serving cell, cell reselection to a cell on a lower priority NR frequency or inter-RAT frequency than the serving frequency shall be performed if:

The serving cell fulfils Squal<Thresh_{Serving,LowQ} and a cell of a lower priority NR or E-UTRAN RAT/frequency fulfils Squal>Thresh_{X,LowQ} during a time interval Treselection_{RAT}.

Otherwise, cell reselection to a cell on a lower priority NR frequency or inter-RAT frequency than the serving frequency shall be performed if:

The serving cell fulfils Srxlev<Thresh_{Serving,LowP} and a cell of a lower priority RAT/frequency fulfils Srxlev>Thresh_{X,LowP} during a time interval Treselection_{RAT}; and More than 1 second has elapsed since the UE camped on the current serving cell. Cell reselection to a higher priority RAT/frequency shall take precedence over a lower priority RAT/frequency if multiple cells of different priorities fulfil the cell reselection criteria.

If more than one cell meets the above criteria, the UE shall reselect a cell as follows: If the highest-priority frequency is an NR frequency, the highest ranked cell among the cells on the highest priority frequency(ies) meeting the criteria according to clause 5.2.4.6;

If the highest-priority frequency is from another RAT, the strongest cell among the cells on the highest priority frequency(ies) meeting the criteria of that RAT.

TS38.304 v17.3.0 describes in 5.2.4.6 Intra-frequency and equal priority inter-frequency Cell Reselection criteria.

The cell-ranking criterion Rs for serving cell and Rn for neighboring cells is defined by:

Rs=Qmeas,s+Qhyst−Qoffsettemp

Rn=Qmeas,n−Qoffset−Qoffsettemp
where:
Qmeas RSRP measurement quantity used in cell reselections.
Qoffset For intra-frequency: Equals to Qoffsets,n, if Qoffsets,n is valid,
otherwise this equals to zero.

For inter-frequency: Equals to Qoffsets,n plus Qoffsetfrequency, if Qoffsets,n is valid, otherwise this equals to Qoffsetfrequency.

Qoffsettemp Offset temporarily applied to a cell as specified in TS 38.331 [3].

The UE shall perform ranking of all cells that fulfil the cell selection criterion S, which is defined in 5.2.3.2.

The cells shall be ranked according to the R criteria specified above by deriving Qmeas,n and Qmeas,s and calculating the R values using averaged RSRP results. If rangeToBestCell is not configured, the UE shall perform cell reselection to the highest ranked cell. If this cell is found to be not-suitable, the UE shall behave according to clause 5.2.4.4.

If rangeToBestCell is configured, then the UE shall perform cell reselection to the cell with the highest number of beams above the threshold (i.e., absThreshSS-BlocksConsolidation) among the cells whose R value is within rangeToBestCell of the R value of the highest ranked cell. If there are multiple such cells, the UE shall perform cell reselection to the highest ranked cell among them. If this cell is found to be not-suitable, the UE shall behave according to clause 5.2.4.4.

In all cases, the UE shall reselect the new cell, only if the following conditions are met:
the new cell is better than the serving cell according to the cell reselection criteria specified above during a time interval Treselection_{RAT};
more than 1 second has elapsed since the UE camped on the current serving cell.

If rangeToBestCell is configured but absThreshSS-BlocksConsolidation is not configured on an NR frequency, the UE considers that there is one beam above the threshold for each cell on that frequency.

In Rel. 17 Baseline (TS38.331 v17.3.0) are described the data NTN cells broadcast (SIB19):
ntn-Config-r17 (ephemeris data, common TA parameters, k_offset, validity duration for UL sync information and epoch);
referenceLocation-r17 (Reference location of the serving cell, e.g., used for measurement initiation in IDLE/INACTIVE mode);
distanceThresh-r17 (distance from the serving cell reference location);
t-Service-r17 (indicates the time information on when a cell provided via NTN quasi-Earth fixed system is going to stop serving the area it is currently covering);
ntn-NeighCellConfigList-r17 (a list of NTN neighbour cells including their ntn-Config, carrier frequency and Physical Cell ID. This set includes all elements of ntn-NeighCellConfigList and all elements of ntn-NeighCellConfigListExt. If ntn-Config is absent for an entry in ntn-NeighCellConfigListExt, the ntn-Config provided in the entry at the same position in ntn-NeighCellConfigList applies.)

This is depicted in FIG. 2. It can be seen the cell reference location (If cell beam points straight to ground, it coincides with sub-satellite point.)

For cell re-selection, there is no explicit differentiation between TN and NTN cells. Considering the large cell size of non-terrestrial networks, many UEs may need to perform cell re-selection and subsequently random access at a given time, leading to RACH congestion and high network signaling load.

Depending on NTN constellation assumptions (e.g., propagation delay and satellite speed) and UE density, a potentially very large number of UEs may need to perform cell re-selection and subsequently random access at a given time. A high number of UEs that try to perform random access and/or (conditional) handover may result in RACH congestion and high network signaling load.

Considering the large cell size of non-terrestrial networks, many UEs may need to perform cell re-selection and subsequently random access at a given time, leading to RACH congestion and high network signaling load.

FIG. 3 shows the Moving NTN cell situation. This application gives a solution for this cited problem. The solution is characterized by that a UE receives a mapping from the network/gNB and if there is data to transmit, UE determines candidate cell for cell re-selection and for potentially performing random access at candidate cell based on provided mapping. The mapping is based on data volume thresholds and/or PLMN ID and/or cell ID and/or cell type and/or contention resolution timer.

The benefits of implementing an aspect of the invention are the following: less network and UE signaling, reduced RA congestion and network load, UE energy savings. No uplink signaling required. UE can remain in IDLE/INACTIVE mode, since mapping for cell re-selection will be provided via system information message. Network enhancements are NTN and/or TN candidate cells will be configured and selected based on network information (e.g., candidate cells' load). Network load and random access can be enhanced by configuring data volume thresholds, contention resolution timers, and selecting candidate cells.

### BRIEF DESCRIPTION OF THE DRAWINGS

The application file contains at least one drawing executed in color. Copies of this patent application publication with color drawing(s) will be provided by the Office upon request and payment of the necessary fee.

FIG. 1 shows large cell size of non-terrestrial networks

FIG. 2 shows the NTN cells broadcast

FIG. 3 shows the NTN constellation assumption

FIG. 4 shows network/gNB and UE process interaction

FIG. 5 shows Earth-moving NTN cells

FIG. 6 shows a first embodiment of NTN-NTN cell re-selection

FIG. 7 shows a second embodiment of NTN-TN cell re-selection

FIG. 8 shows a third embodiment of NTN-TN cell re-selection

FIG. 9 shows a fourth embodiment of macro-small cell re-selection

### DETAILED DESCRIPTION

The detailed description set forth below, with reference to annexed drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In particular, although terminology from 3GPP 5G NR may be used in this disclosure to exemplify embodiments herein, this should not be seen as limiting the scope of the invention

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other aspects, features and advantages of the enclosed embodiments will be apparent from the following description.

In some embodiments, a more general term “network node” may be used and may correspond to any type of radio network node or any network node, which communicates with a UE (directly or via another node) and/or with another network node. Examples of network nodes are NodeB, MeNB, ENB, a network node belonging to MCG or SCG, base station (BS), multi-standard radio (MSR) radio node such as MSR BS, eNodeB, gNodeB, network controller, radio network controller (RNC), base station controller (BSC), relay, donor node controlling relay, base transceiver station (BTS), access point (AP), transmission points, transmission nodes, RRU, RRH, nodes in distributed antenna system (DAS), core network node (e.g. Mobile Switching Center (MSC), Mobility Management Entity (MME), etc), Operations & Maintenance (O&M), Operations Support System (OSS), Self Optimized Network (SON), positioning node (e.g. Evolved-Serving Mobile Location Centre (E-SMLC)), Minimization of Drive Tests (MDT), test equipment (physical node or software), etc.

In some embodiments, the non-limiting term user equipment (UE) or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, PDA, PAD, Tablet, mobile terminals, smart phone, laptop embedded equipped (LEE), laptop mounted equipment (LME), USB dongles, UE category MI, UE category M2, ProSe UE, V2V UE, V2X UE, etc.

In some embodiments, the term Public Land Mobile Network (PLMN) may be used and may refer to any wireless communication system within one country, provided by a specific Mobile Network Operator (MNO), where a combination of wireless communication services are available. A PLMN may be used for servicing both terrestrial (e. g., cellular networks or WLAN) and non-terrestrial networks (e.g., satellite networks). A PLMN is identified by a globally unique PLMN ID, which is a combination of a Mobile Country Code and a Mobile Network Code.

Additionally, terminologies such as base station/gNodeB and UE should be considered non-limiting and do in particular not imply a certain hierarchical relation between the two, in general, “gNodeB” could be considered as device 1 and “UE” could be considered as device 2 and these two devices communicate with each other over some radio channel. And in the following the transmitter or receiver could be either gNodeB (gNB), or UE.

In some embodiments, the term of contention resolution timer may be used and may refer to the process of resolving contention or conflicts among multiple UEs trying to access the shared radio resources simultaneously. UEs initiate communication by sending a random access preamble to the network. After sending the random access preamble, the UE starts the contention resolution timer. If the UE receives a contention resolution message within the timer's duration, the contention is resolved, and the UE can proceed with the data transmission.

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc readonly memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment. Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the fimctions/acts specified in the flowchart diagrams and/or block diagrams

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The flowchart diagrams and/or block diagrams in the figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

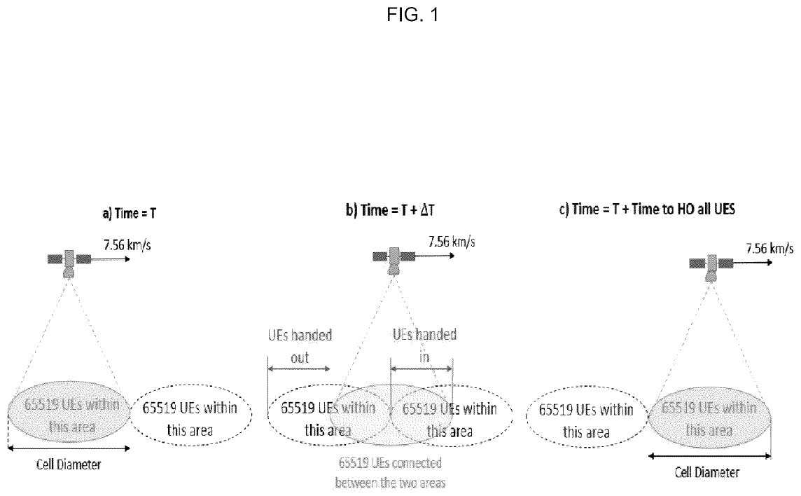

FIG. 1 shows large cell size of non-terrestrial networks.

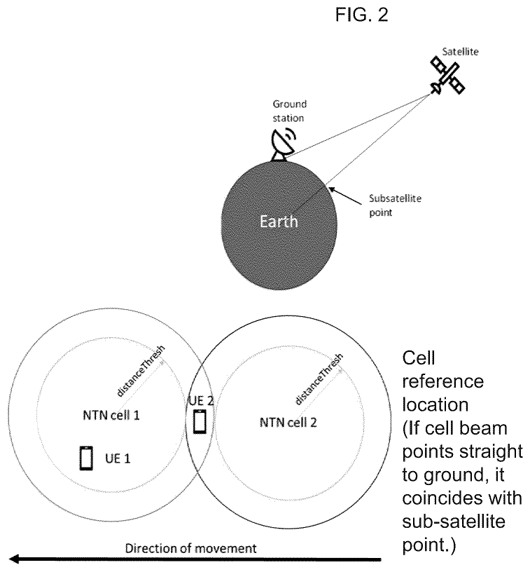

FIG. 2 shows the NTN cells broadcast.

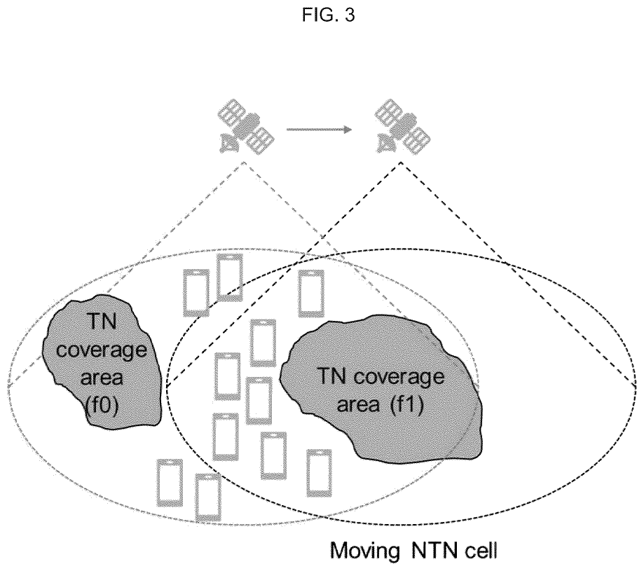

FIG. 3 shows the NTN constellation assumption and the problem statement.

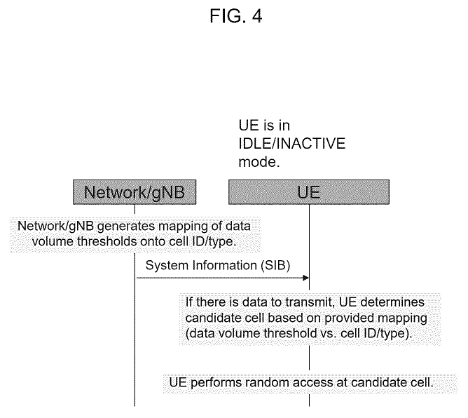

FIG. 4 shows the interaction of gNB and UE.

Network/gNB generates mapping of data volume thresholds onto cell ID and/or type and/or PLMN ID and/or contention resolution timer. Then it sends System Information (SIB) to UE(s).

UE is in IDLE/INACTIVE mode and receives System Information Block (SIB) from Network/gNB. If there is data to transmit, UE determines candidate cell based on provided mapping (data volume threshold versus cell ID and/or cell type and/or PLMN ID and/or contention resolution timer). UE performs random access at candidate cell.

In some embodiments, the network/gNB configures the UE with this mapping (data volume threshold versus cell ID and/or cell type and/or PLMN ID and/or contention resolution timer) via Non-Access Stratum signaling.

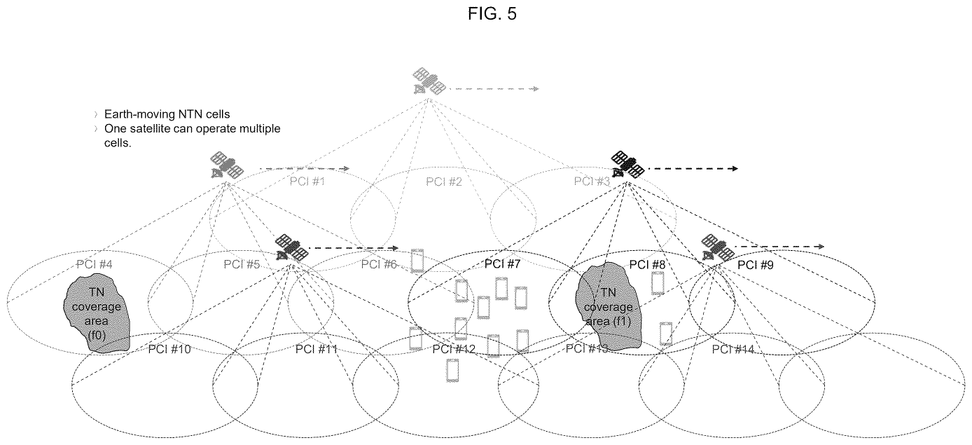

FIG. 5 shows Earth-moving NTN cells. One satellite can operate multiple cells.

TN and NTN can inter-work and exchange information, e.g., on core network level. Integrated network is aware of TN coverage, radio cell neighborship relations, and cell load conditions. UEs can either access TN or NTN cells, depending on subscription and provided system information (e.g., TN cells may be barred). Further, network can determine and pre-select neighbor cells (e.g., TN intra-frequency or inter-frequency cells, NTN or HAPS cells) that should be considered by UEs. One satellite may operate several beams that are recognized as NTN cells. UE is in IDLE or INACTIVE mode. It can be stationary or mobile.

An aspect of the invention is an enhancement to be executed on top of “baseline” cell re-selection mechanism.

When preparing the system information including the list of potential candidate cells, the network/gNB collects data of available cells (TN, NTN, HAPS, UAV) in a certain geographical area, in particular, ephemeris data (and/or predicted flight path) of satellites and/or aerials belonging to a managed and/or inter-working constellation of NTN nodes, TN cell coverage data, as well as other aerial or space-born nodes that can provide stationary, nomadic, or moving network coverage.

Besides determining “availability” of cells, the network determines cell-specific load conditions.

Cell availability and load conditions are considered by the network/gNB when creating a mapping of data volume thresholds onto cell ID and/or cell type. In addition, data volume thresholds are mapped onto PLMN ID and/or contention resolution timer.

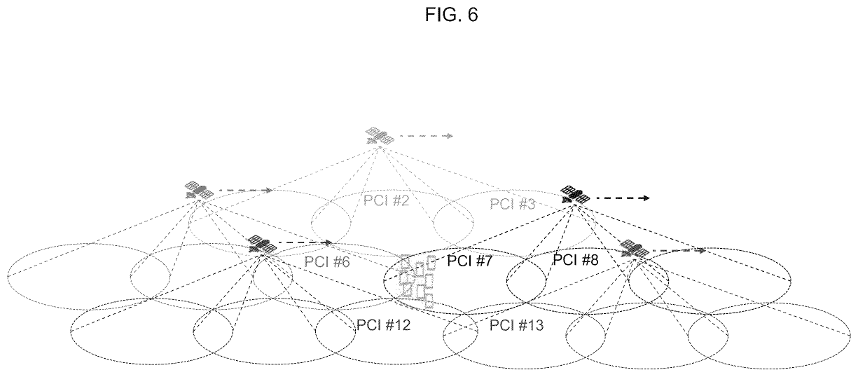

FIG. 6 shows a first embodiment NTN-NTN cell re-selection. NTN cell size can be huge. There may be no alternative cells for re-selection, but a high number of UEs may collide when performing random access.

In FIG. 6 Issued by Cell #7:

| UE data | UE data | | Additional | |
|---|---|---|---|---|
| volume | volume | | back-off timer | |
| index | threshold | | (subframes) | |
| 0 1 2 3 | V0 V1 V2 V3 | [symbol] | Sf32 Sf24 Sf16 Sf8 | [symbol] |

For example: the higher the data volume threshold, the lower the additional back-off timer (e.g., contention resolution timer) or vice versa. Data volume threshold can be specified in, e.g., bytes or %. Clustering (index range) depends on bit-level encoding. UE buffer size may depend on HW characteristics.

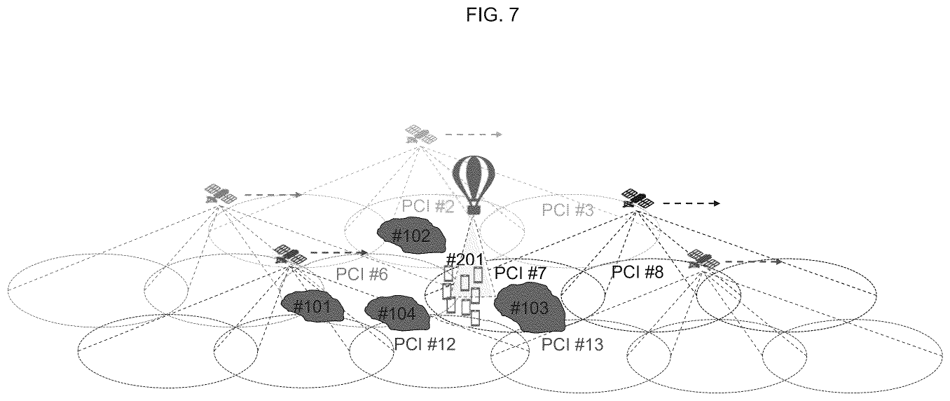

FIG. 7 shows a second embodiment of NTN-TN cell re-selection. NTN and TN cells may overlap. Mobile Network Operator MNO may want to protect TN from high load, but a high number of UEs may collide when performing random access.

In FIG. 7 Issued by Cell #7:

| UE data | UE data | | Candidate |
|---|---|---|---|
| volume | volume | Cell | Cell ID |
| index | threshold | Type | (incl. order) |
| 0 | V0 | NTN | 6, 2, 12 |
| 1 | V1 | NTN | 12, 2, 6 |
| 2 | V2 | NTN, TN | 201, 103 |
| 3 | V3 | TN | 104, 103 |

This embodiment means a joint network management of NTN and TN cells. Data volume threshold can be specified in, e.g., bytes or %. Clustering (index range) depends on bit-level encoding. UE buffer size may depend on HW characteristics.

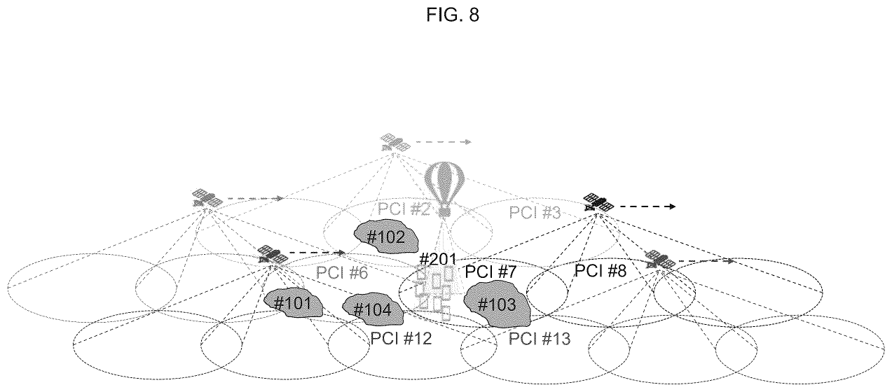

FIG. 8 shows a third embodiment of the NTN-TN cell re-selection.

NTN and TN cells may overlap. Mobile Network Operator MNO may want to protect TN from high load, but a high number of UEs may collide when performing random access.

In FIG. 8 Issued by Cell #7:

| UE data | UE data | | Candidate | Additional |
|---|---|---|---|---|
| volume | volume | Cell | Cell ID | back-off timer |
| index | threshold | Type | (incl. order) | (subframes) |
| 0 | V0 | NTN | 6, 2, 12 | |
| 1 | V1 | NTN | 12, 2, 6 | sf24 |
| 2 | V2 | NTN, TN | 201, 103 | sf16 |
| 3 | V3 | TN | 104, 103 | sf8 |

This embodiment means also a joint network management of NTN and TN cells. The additional back-off timer (e.g., contention resolution timer) is applied for avoiding congestion of certain cells. Data volume threshold can be specified in, e.g., bytes or %. Clustering (index range) depends on bit-level encoding. UE buffer size may depend on HW characteristics.

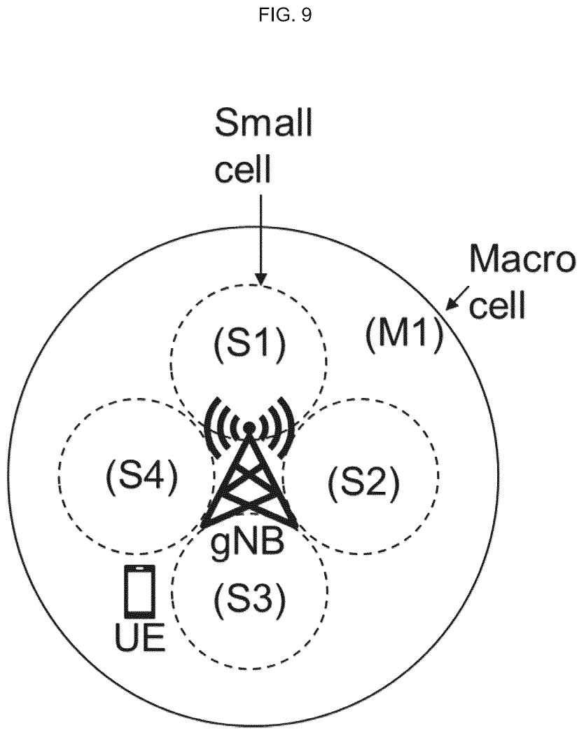

FIG. 9 shows a fourth embodiment of macro-small cell re-selection. In this case, the UE receives mapping for cell-reselection, which mapping is provided by gNB.

| UE data | UE data | | | Additional |
|---|---|---|---|---|
| volume | volume | Cell | Candidate | back-off timer |
| index | threshold | Type | Cell ID | (subframes) |
| 0 | V0 | Macro | M1 | — |
| 1 | V1 | Macro | M1 | sf24 |
| 2 | V2 | Small | S3 | sf16 |
| 3 | V3 | Small | S4 | sf8 |

Network/gNB direct UEs to different cells, depending on data volume. For example, the network/gNB determined mapping directs UEs with high data volume to small cells (e.g., S3, S4). UEs with low data volume are configured to re-select a macro cell (e.g., M1). Further, network/gNB additionally configures a back-off or contention resolution timer, e.g., in case of high cell load.

1. A method for enhanced cell re-selection in a wireless network, wherein a User Equipment UE receives a mapping from the network/gNB and if there is data to transmit, the UE determines candidate cell for cell re-selection and for potentially performing random access at candidate cell based on provided mapping.

2. The method according to claim 1, wherein the mapping is based on data volume and cell ID and/or cell type and/or PLMN ID and/or contention resolution timer.

3. The method according to claim 1, wherein the UE determines cell re-selection candidate based on network-generated mapping and UE's buffer status.

4. The method according to claim 1, wherein the network/gNB generates the mapping and provides the mapping as part of system information message(s) to the UE(s).

5. The method according to claim 1, wherein the network/gNB configures the UE with this mapping via Non-Access Stratum signaling.

6. An apparatus for enhanced cell re-selection method, the apparatus comprising a wireless transceiver, a processor coupled with a memory in which computer program instructions are stored, said instructions being configured to implement the method of claim 1.

7. An apparatus for enhanced a cell re-selection method, the apparatus comprising a wireless transceiver, a processor coupled with a memory in which computer program instructions are stored, said instructions being configured to implement the method of claim 4.

8. User Equipment comprising an apparatus according to claim 6.

9. A base station (gNB) comprising an apparatus according to claim 6.

10. A wireless communication system, wherein the gNB comprises a processor coupled with a memory in which computer program instructions are stored, said instructions being configured to implement the method of claim 4,
wherein the user equipment (UE) comprises a processor coupled with a memory in which computer program instructions are stored, said instructions being configured to implement a method for enhanced cell re-selection in a wireless network, wherein the User Equipment UE receives a mapping from the network/gNB and if there is data to transmit, the UE determines candidate cell for cell re-selection and for potentially performing random access at candidate cell based on provided mapping.
